(19) United States
(12) Patent Application Publication
(10) Pub. No.: US 2004/0093613 A1
(43) Pub. Date: May 13, 2004

(54) Fee-based programming charge based on content viewed by user

(75) Inventors: Stephen B. Boston, Cedar Park, TX (US); Michael Wayne Brown, Georgetown, TX (US); Michael A. Paolini, Austin, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY

(21) Appl. No.: 10/290,222

(22) Filed: Nov. 7, 2002

(51) Int. Cl. H04N 7/16

(52) U.S. Cl. 725/21

(57) ABSTRACT

In an exemplary embodiment of the present invention, the users of a personal video recorder (PVR) system are identified. A determination is made regarding the viewing time of fee-based programming for each user of the system. The users are charged for the programming based on his or her viewing time. The invention may be applied to the cost of basic cable service (fixed cost service), pay-per-view, or special event programming.

### CROSS REFERENCE TO RELATED APPLICATIONS

The present application shares specification text and figures with the following co-pending applications, which were filled concurrently with the present application: application Ser. No. ______ (Attorney Docket Number AUS920020417US1) “PVR Credits by User;” and application Ser. No. ______ (Attorney Docket Number AUS920020418US1) “User Specific Cable/Personal Video Recorder Preferences.” The content of the co-pending applications are incorporated herein by reference.

### BACKGROUND OF THE INVENTION

1. Technical Field

The field of the invention is data processing, or, more specifically, methods, systems, and products for a fee-based programming charge based on the content viewed by a specific user.

2. Description of the Related Art

The use of personal video recorders (PVRs) have become increasingly common. PVR systems provide users the ability to watch different types of programming. Particular channels or events may be viewed by users for additional fees. Many PVR systems are utilized by more than one user; however, bills for the usage of PVR systems do not include billing details for each user according to the programming viewed. Therefore, there is a need for a method and system of charging a specific user based on the programming viewed.

### SUMMARY OF THE INVENTION

In an exemplary embodiment of the present invention, the users of a personal video recorder (PVR) system are identified. A determination is made regarding the viewing time of fee-based programming for each user of the system. The users are charged for the programming based on his or her viewing time. The invention may be applied to the cost of basic cable service (fixed cost service), pay-per-view, or special event programming.

While the term cable is utilized in the Specification of the present invention, the term is meant to include all forms and providers of electronic video data.

The determination of cost for each user of basic cable is obtained from the formula

Costᵤₛₑᵣ=Wᵤₛₑᵣ×Cost_{Total}×Timeᵤₛₑᵣ/Time_{Total}

wherein Wᵤₛₑᵣ is a weight associated with each user allowing for non-uniform cost distribution, Cost_{Total} is the general service fee, Timeᵤₛₑᵣ is the viewing time for a specific user, and Time_{Total} is the summation of viewing times for all users.

The determination of cost for each user of pay-per-view and special event programming is obtained from the formula

Costᵤₛₑᵣ=Wᵤₛₑᵣ×Cost_{SE}×Timeᵤₛₑᵣ/Time_{Total}

wherein Costᵤₛₑᵣ is the cost for a particular user, Wᵤₛₑᵣ is a weight for each user allowing for non-uniform cost distribution, Cost_{SE} is the cost of the special event programming, Timeᵤₛₑᵣ is the time the user viewed the special event, and Time_{Total} is the sum of all user viewing times for the special event.

### DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1 is an exemplary block diagram illustrating a personal video record as may be utilized by the present invention;

FIG. 2 is a flow chart depicting a set of steps that may be carried out to implement a fee-based programming charge based on content viewed by a user for general programming; and

FIG. 3 is a flow chart illustrating a set of steps that may be carried out to implement a fee-based programming charge based on content viewed by a user for special event programming.

### DESCRIPTION OF THE PREFERRED EMBODIMENT

Referring now to the drawing figures, in which like numerals indicate like elements or steps throughout the several views, the preferred embodiment of the present invention will be described. In general, the present invention provides for a fee-based programming charge based on the content viewed by a specific user.

While the term cable is utilized in the Specification of the present invention, the term is meant to include all forms and providers of electronic video data.

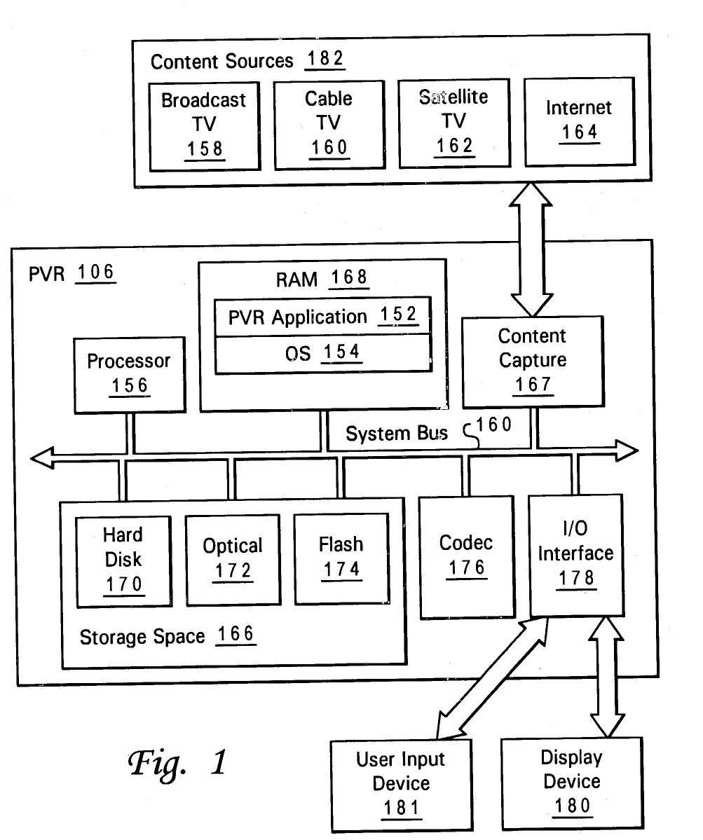

With reference now to FIG. 1, an exemplary block diagram illustrating a personal video recorder as may be utilized by the present invention is shown. FIG. 1 sets forth a block diagram of automated computing machinery comprising a PVR 106 according to an exemplary embodiment of the present invention. PVR 106 of FIG. 1 includes at least one computer processor 156 as well as random access memory (RAM) 168. Stored in RAM 168 is a PVR application program 152 implementing inventive steps of the present invention.

Also stored in RAM 168 is an operating system (OS) 154. Embodiments of the present invention are directed towards personal video preference settings for multiple users. It will occur to readers skilled in the art that much of the work of administering user accounts for many users may be downshifted to a multi-user operating system such as Unix, Linux, or Microsoft NT_{TM}. The multi-user features of typical embodiments of the present invention, however, tend to be features of application software. PVRs according to embodiments of the present invention, therefore, may use single-user operating systems, such as Microsoft's Disk Operating System or “DOS,” as well as multi-user operating systems, or even operating systems developed as special purpose systems for use in PVR according to this invention.

In a preferred embodiment, RAM 168 includes storage space for storing user specific preferences and/or account information. Additionally, RAM 168 contains application software required to obtain and verify the current one or more users of PVR 106.

PVR 106 includes storage space 166 for programming. Storage space 166 may be implemented as hard disk space 170, optical drive space 172, electrically erasable programmable read-only memory space (EEPROM or Flash memory) 174, RAM drives (not shown), or as any other type of computer memory capable of receiving and storing recorded content.

The example PVR 106 includes a subsystem for content capture 167. The subsystem for content capture 167 is implemented in typical embodiments according to content sources 182 and may include in various embodiments a broadcast television tuner for receipt of broadcast television 158, a cable box for receipt of cable television 160, a satellite receiver for receipt of satellite television 162, and an Internet connection for downloading recordable content from the Internet 164.

PVR 106 includes a codec 176, which may take the form of a video card logically connected to the system bus of a personal computer, or other forms as will occur to those of skill in the art. Codec 176 provides video and audio output from recorded programming in storage space 166 to an input/output interface 178. Additionally, codec 176 may also provide changes in video compression or video quality as needed in particular instances. The input/output interface provides video and audio output to a display device 180. In the case of PVRs implemented with connection to televisions, the display device 180 is a television. In the case of PVRs implemented as general purpose computers, the display device is often implemented as a computer screen. Display device 180 is any device, as will occur to those of skill in the art, capable of displaying video and audio content.

PVR 106 includes an input/output interface 178. The input/output interface 178 in PVRs implemented as general purpose computers is a computer interface including, for example, conventional software drivers and computer hardware for controlling output to display devices 180 such as computer screens, as well as user input from user input devices 181 such as computer keyboards and computer mice. In the case of PVRs as set top boxes, an input/output interface 178 comprises, for example, software drivers and computer hardware for controlling displays on display devices 180 such as television screens and user input from user input devices 181 such as remote control devices.

PVR 106 includes input devices 181 allowing the identification of a user application Ser. No. ______ entitled “User Specific Thumbs Up/Down” includes teachings on the methods and means for identifying a user and is specifically incorporated herein.

Those skilled in the art will readily understand that a cable box may be implemented in a substantially similar manner as the PVR described above and be used to carry out the present invention.

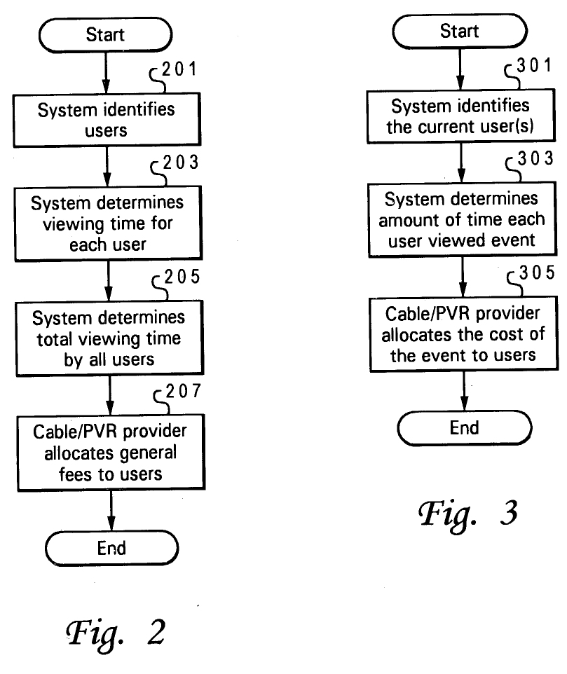

Now with reference to FIG. 2, a flow chart depicting a set of steps that maybe carried out to implement a fee-based programming charge based on content viewed by a user for general programming in a preferred embodiment is illustrated. General programming refers to programming a user of a PVR system receives without paying additional costs. The general programming is included within the standard price of the service for the user. The process for allocating the costs of general programming begins at the end of the billing period for the service provided. During the billing period, the PVR system or provider maintains information about the total viewing time on the PVR system and the viewing time for each user. For example and with reference back to FIG. 1, RAM 168 includes storage space for data regarding each user's view time and the total time the system was utilized in an exemplary embodiment. In a preferred embodiment, hereinafter described, RAM 168 includes a table or other similar data structure which maintains a listing of all users of the PVR system and data for each user such as viewing time for current billing period. Additionally, the PVR system has a communication link with the PVR provider allowing user information to be transmitted from the PVR system to the PVR provider.

The process for allocating the general costs of the PVR bill begins at step 201 wherein the PVR system identifies the users of the system. The PVR system examines its memory for a listing of all users of the system. Upon identifying all of the users of the PVR system, the process continues and the PVR system determines the viewing time for each user as depicted at step 203. During the billing period, the PVR system will have maintained information regarding each user's viewing time in a user data table. The user's viewing time is incremented whenever the user views general programming or the PVR system records general programming on behalf of the user. The viewing times for each of the users of the PVR system are summed resulting in a total viewing time for all users during the billing period as illustrated at step 205. It is possible the total viewing time may exceed the amount of time the PVR system was utilized. Such a case will arise when there are more than one concurrent users of the system.

Following a determination of the users of the system (step 201), the viewing time for each user (step 203), and the total viewing time for each user (step 205), the process continues and the PVR provider allocates the general fees to the users of the system as illustrated at step 207. A PVR provider may obtain the user viewing information from a PVR system throughout the month or at the end of a billing cycle.

The manner in which the PVR provider allocates the costs of general fees may vary. In a preferred embodiment, the cost for each user is expressed by the equation:

Costᵤₛₑᵣ=Wᵤₛₑᵣ×Cost_{Total}×Timeᵤₛₑᵣ/Time_{Total}

wherein Wᵤₛₑᵣ is a weight associated with each user allowing for non-uniform cost distribution, Cost_{Total} is the general service fee, Timeᵤₛₑᵣ is the viewing time for a specific user, and Time_{Total} is the summation of viewing times for all users. Those skilled in the art will readily recognize the total cost maybe allocated in other manners, such as adding additional factors to the above equation.

With reference now to FIG. 3, a flow chart illustrating a set of steps that may be carried out to implement a fee-based programming charged based on content viewed by a user for special event programming for a preferred embodiment is depicted. Special event programming refers to any programming in which a user incurs an additional cost to the general service fee for viewing. Examples of special event programming include pay-per-view movies and sporting events in which the user must pay additional fees to view.

In a preferred embodiment, hereinafter described in conjunction with steps of FIG. 3, the PVR system maintains a table or other similar data structure containing user information regarding the viewing time for a special event. The PVR system is in communicative contact with the PVR provider allowing the PVR system to transmit the user information to the PVR provider upon the completion of the special event.

The process for allocating the costs of a special event programming begins as depicted at step 301 with the PVR system identifying the current users of the system. A user need not actually be viewing the special event programming, as the PVR system may record the special event programming on behalf of a user. As the special event programming is being received by the PVR system, the PVR system periodically updates the current users' viewing time information as illustrated at step 303. In alternative embodiments, the PVR system does not periodically update the user information records, but updates the information when the PVR system begins receiving special event programming and if a user quits viewing special event programming. In such an embodiment, the PVR system assumes the viewers of the special event programming will watch the entire program and updates the user records accordingly. If a user quits viewing a program, the system updates the viewing time for that user as appropriate. Those skilled in the art will recognize other variations such as only updating at the end of the special event programming and when a user quits viewing are possible without deviating from the spirit and scope of the present invention.

After the PVR system identifies the current users (step 301) and determines the amount of time each user viewed the special event programming (step 303) the PVR provider allocates the cost of the event to the users as illustrated at step 305. The PVR provider obtains the user viewing information from the PVR system. In a preferred embodiment, the user information is transmitted at the conclusion of the special event programming. The manner in which the special event programming is allocated to the users is expressed by the equation:

Costᵤₛₑᵣ=Wᵤₛₑᵣ×Cost_{SE}×Timeᵤₛₑᵣ/Time_{Total}

wherein Costᵤₛₑᵣ is the cost for a particular user, Wᵤₛₑᵣ is a weight for each user allowing for non-uniform cost distribution, Cost_{SE} is the cost of the special event programming, Timeᵤₛₑᵣ is the time the user viewed the special event, and Time_{Total} is the sum of all user viewing times for the special event. Additionally, the PVR provider may not charge a user for viewing a programming if the user quit watching the program within a certain period of time (zero cost time). Those skilled in the art will readily recognize other factors may be added to the above equation to divide the cost of the special event programming in other ways without departing from the spirit and scope of the present invention.

It will be understood from the foregoing description that modifications and changes may be made in various embodiments of the present invention without departing its true spirit. For example, the user information may be stored solely at the PVR system or provider. The descriptions in this specification are for purposes of illustration only and are not to be construed in a limiting sense. The scope of the present invention is limited only by the language of the following claims.

What is claimed is:

1. A method of allocating the costs of viewing programming on a personal video recorder (PVR) systems, said method comprising the steps of:
identifying one or more users of said PVR system;
determining an amount of time utilized by each of said one or more users of said PVR system for viewing programming;
allocating to each one or more users a percentage of the cost of viewing programming.

2. The method of claim 1, wherein said percentage of the cost of viewing said programming is determined by the equation
Costᵤₛₑᵣ=Wᵤₛₑᵣ×Cost_{Total}×Timeᵤₛₑᵣ/Time_{Total}
wherein Wᵤₛₑᵣ is a weight associated with each one or more users allowing for a non-uniform cost distribution, Cost_{Total} is a general service fee, Timeᵤₛₑᵣ is a viewing time for a specific user, and Time_{Total} is a summation of viewing times for all of said one or more users.

3. The method of claim 1, wherein said percentage of the cost of viewing said programming is determined by the equation
Costᵤₛₑᵣ=Wᵤₛₑᵣ×Cost_{SE}×Timeᵤₛₑᵣ/Time_{Total}
wherein Costᵤₛₑᵣ is a cost for a particular user, Wᵤₛₑᵣ is a weight for each of said one or more users allowing for a non-uniform cost distribution, Cost_{SE} is a cost of a special event programming, Timeᵤₛₑᵣ is a time the user viewed the special event, and Time_{Total} is a sum of all user viewing times for the special event

4. The method of claim 3, wherein said Wᵤₛₑᵣ is 0 if Timeᵤₛₑᵣ is less than a zero cost time.

5. The method of claim 1 wherein said cost of viewing programming comprises the cost of viewing basic service.

6. The method of claim 1 wherein said cost of viewing programming comprises the cost of viewing pay-per-view programming.

7. The method of claim 1 wherein said cost of viewing programming comprises the cost of viewing special events.

8. A system for allocating the costs of viewing programming on a personal video recorder (PVR) systems, said system comprising:
means for identifying one or more users of said PVR system;
means for determining an amount of time utilized by each of said one or more users of said PVR system for viewing programming;
means for allocating to each one or more users a percentage of the cost of viewing programming.

9. The system of claim 8, wherein said percentage of the cost of viewing said programming is determined by the equation
Costᵤₛₑᵣ=Wᵤₛₑᵣ×Cost_{Total}×Timeᵤₛₑᵣ/Time_{Total}
wherein Wᵤₛₑᵣ is a weight associated with each one or more users allowing for a cost distribution, Cost_{Total} is a general service fee, Timeᵤₛₑᵣ is a viewing time for a specific user, and Time_{Total} is a summation of viewing times for all of said one or more users.

10. The system of claim 8, wherein said percentage of the cost of viewing said programming is determined by the equation
Costᵤₛₑᵣ=Wᵤₛₑᵣ×Cost_{SE}×Timeᵤₛₑᵣ/Time_{Total}
wherein Costᵤₛₑᵣ is a cost for a particular user, Wᵤₛₑᵣ is a weight for each of said one or more users allowing for a non-uniform cost distribution, Cost_{SE} is a cost of a special event programming, Timeᵤₛₑᵣ is a time the user viewed the special event, and Time_{Total} is a sum of all user viewing times for the special event

11. The system of claim 10, wherein said Wᵤₛₑᵣ is 0 if Timeᵤₛₑᵣ is less than a zero cost time.

12. The system of claim 8 wherein said cost of viewing programming comprises the cost of viewing basic service.

13. The system of claim 8 wherein said cost of viewing programming comprises the cost of viewing pay-per-view programming.

14. The system of claim 8 wherein said cost of viewing programming comprises the cost of viewing special events.

15. A computer program product for allocating the costs of viewing programming on a personal video recorder (PVR) systems, said computer program product comprising:
programming instructions for identifying one or more users of said PVR system;
programming instructions for determining an amount of time utilized by each of said one or more users of said PVR system for viewing programming;
programming instructions for allocating to each one or more users a percentage of the cost of viewing programming.

16. The computer program product of claim 15, wherein said percentage of the cost of viewing said programming is determined by the equation
Costᵤₛₑᵣ×Wᵤₛₑᵣ×Cost_{Total}×Timeᵤₛₑᵣ/Time_{Total}
wherein Wᵤₛₑᵣ is a weight associated with each one or more users allowing for a non-uniform cost distribution, Cost_{Total} is a general service fee, Timeᵤₛₑᵣ is a viewing time for a specific user, and Time_{Total} is a summation of viewing times for all of said one or more users.

17. The computer program product of claim 15, wherein said percentage of the cost of viewing said programming is determined by the equation
Costᵤₛₑᵣ=Wᵤₛₑᵣ×Cost_{SE}×Timeᵤₛₑᵣ/Time_{Total}
wherein Costᵤₛₑᵣ is a cost for a particular user, Wᵤₛₑᵣ is a weight for each of said one or more users allowing for a non-uniform cost distribution, Cost_{SE} is a cost of a special event programming, Timeᵤₛₑᵣ is a time the user viewed the special event, and Time_{Total} is a sum of all user viewing times for the special event

18. The computer program product of claim 17, wherein said Wᵤₛₑᵣ is 0 if Timeᵤₛₑᵣ is less than a zero cost time.

19. The computer program product of claim 15 wherein said cost of viewing programming comprises the cost of viewing basic service.

20. The computer program product of claim 15 wherein said cost of viewing programming comprises the cost of viewing pay-per-view programming.

21. The computer program product of claim 15 wherein said cost of viewing programming comprises the cost of viewing special events.
